(19) United States
(12) Patent Application Publication
(10) Pub. No.: US 2017/0298826 A1
(43) Pub. Date: Oct. 19, 2017

(54) Industrial gas turbine engine with turbine airfoil cooling

(71) Applicants: John E. Ryznic, Jupiter, FL (US); Russell B. Jones, North Palm Beach, FL (US); Joseph D. Brostmeyer, Jupiter, FL (US); Justin T. Cejka, Palm Beach Gardens, FL (US)

(72) Inventors: John E. Ryznic, Jupiter, FL (US); Russell B. Jones, North Palm Beach, FL (US); Joseph D. Brostmeyer, Jupiter, FL (US); Justin T. Cejka, Palm Beach Gardens, FL (US)

(21) Appl. No.: 15/131,426

(22) Filed: Apr. 18, 2016

(51) Int. Cl. F02C 7/18; F01P 1/06; F01D 5/18; F01D 15/10; H02K 7/18; F02C 3/04

(52) U.S. Cl. CPC F02C 7/18; H02K 7/1823; F02C 3/04; F01D 5/18; F01D 15/10; F01P 1/06

(57) ABSTRACT

A process for retrofitting an electric power plant that uses two 60 Hertz large frame heavy duty industrial gas turbine engines to drive electric generators and produce electricity, where each of the two industrial engines can produce up to 350 MW of output power. The process replaces the two 350 MW industrial engines with one twin spool industrial gas turbine engine that is capable of producing at least 700 MW of output power. Thus, two prior art industrial engines can be replaced with one industrial engine that can produce power equal to the two prior art industrial engines.

### GOVERNMENT LICENSE RIGHTS

This invention was made with Government support under contract number DE-FE0023975 awarded by Department of Energy. The Government has certain rights in the invention.

### CROSS-REFERENCE TO RELATED APPLICATIONS

None.

### BACKGROUND OF THE INVENTION

### Field of the Invention

The present invention relates generally to an industrial gas turbine engine, and more specifically to an industrial gas turbine engine with turbine airfoil cooling with spent cooling air that is discharged into the combustor.

### Description of the Related Art Including Information Disclosed Under 37 CFR 1.97 and 1.98

In a gas turbine engine, such as a large frame heavy-duty industrial gas turbine (IGT) engine, a hot gas stream generated in a combustor is passed through a turbine to produce mechanical work. The turbine includes one or more rows or stages of stator vanes and rotor blades that react with the hot gas stream in a progressively decreasing temperature. The efficiency of the turbine—and therefore the engine—can be increased by passing a higher temperature gas stream into the turbine. However, the turbine inlet temperature is limited to the material properties of the turbine, especially the first stage vanes and blades, and an amount of cooling capability for these first stage airfoils.

In an industrial gas turbine engine used for electrical power production, during periods of low electrical demand the engine is reduced in power. During periods of low electrical power demand, prior art power plants have a low power mode of 40% to 50% of peak load. At these low power modes, the engine efficiency is very low and thus the cost of electricity is higher than when the engine operates at full speed with the higher efficiency.

Industrial and marine gas turbine engines used today are shown in FIGS. 1-4 These designs suffer from several major issues that include low component (compressor and turbine) performance for high cycle pressure ratios or low part load component efficiencies or high CO (carbon monoxide) emissions at part load when equipped with low NOx combustors which limit the low power limit at which they are allowed to operate (referred to as the turn-down ratio).

FIG. 1 shows a single shaft IGT (Industrial Gas Turbine) engine with a compressor 1 connected to a turbine 2 with a direct drive electric generator 3 on the compressor end. FIG. 2 shows a dual shaft IGT engine with a high spool shaft and a separate power turbine 4 that directly drives an electric generator 3. FIG. 3 shows a dual shaft aero derivative gas turbine engine with concentric spools in which a high pressure spool rotates around the low pressure spool, and where a separate low pressure shaft that directly drives an electric generator 3. FIG. 4 shows a three-shaft IGT engine with a low pressure spool rotating within a high pressure spool, and a separate power turbine 4 that directly drives an electric generator 3.

The configuration of FIG. 1 IGT engine is the most common for electric power generation and is limited by non-optimal shaft speeds for achieving high component efficiencies at high pressure ratios. The mass flow inlet and exit capacities are limited structurally by AN² (last stage blade stress) and tip speeds that limit inlet and exit diameters due to high tip speed induced Mach # losses in the flow. Therefore for a given rotor speed, there is a maximum inlet diameter and corresponding flow capacity for the compressor and exit diameter and flow capacity for the turbine before the compressor and turbine component efficiencies start to drop off due to high Mach # losses.

Since there is a fixed maximum inlet flow at high pressure ratios on a single shaft, the rotor blades start to get very small in the high pressure region of the compressor flow path. The small blade height at a relatively high radius gives high losses due to clearance and leakage affects. High pressure ratio aircraft engines overcome this limitation by introduction of separate high pressure and low pressure shafts. The high pressure shaft turns at a faster speed allowing for smaller radius while still accomplishing a reasonable work per stage. An example for this is shown in FIG. 3, which is typical of an aero-derivative gas turbine engine used for electrical power production. The speed of the high pressure spool 5 is still limited by having a low speed shaft 6 inside the inner diameter (ID) of the high pressure shaft 5. This drives the high pressure shaft 5 flow path to a higher radius relative to what might otherwise be feasible, which thereby reduces the speed of the high pressure rotor, creating smaller radius blades which reduce the efficiency of the high pressure spool. FIG. 2 arrangement is similarly limited in achieving high component efficiencies at high pressure ratios as FIG. 1 since the entire compressor is on one shaft.

Turn down ratio is the ratio of the lowest power load at which a gas turbine engine can operate (and still achieve CO emissions below the pollution limit) divided by the full 100% load power. Today's gas turbines have a turn down ratio of around 40%. Some may be able to achieve 30%. Low part load operation requires a combination of low combustor exit temperatures and low inlet mass flows. Low CO emissions require a high enough combustor temperature to complete the combustion process. Since combustion temperature must be maintained to control CO emissions, the best way to reduce power is to reduce the inlet mass flow. Typical single shaft gas turbine engines use multiple stages of compressor variable guide vanes to reduced inlet mass flow. The limit for the compressor flow reduction is around 50% for single shaft constant rotor speed compressors as in FIG. 1. The FIG. 3 arrangement is similarly limited as the FIG. 1 arrangement in flow inlet mass flow reduction since the low pressure compressor runs at the constant speed of the generator. In industrial engine that drive electric generators, the turbine that drives the electric generator is set to operate at a constant speed such as 3,600 rpm for a 60 hertz engine in the USA or at 3,000 rpm for a 50 hertz engine in European countries.

The FIG. 4 arrangement is the most efficient option of the current configurations for IGT engines, but is not optimal because the low spool shaft 6 rotates within the high spool shaft 5, and thus a further reduction in the high spool radius cannot be achieved. In addition, if the speed of the low spool shaft 6 is reduced to reduce inlet mass flow, there is a mismatch of angle entering the LPT (Low Pressure Turbine) from the HPT (High Pressure Turbine) and mismatch of the flow angle exiting the LPT and entering the PT (Power Turbine) leading to inefficient turbine performance at part load.

### BRIEF SUMMARY OF THE INVENTION

An industrial gas turbine engine of the type used for electrical power production with a high pressure spool and a low pressure spool in which the two spools can be operated independently so that a turn-down ratio of as little as 12% can be achieved while still maintaining high efficiencies for the engine. An electric generator is connected directly to the high pressure spool and operates at a continuous and constant speed. The low pressure spool is driven by turbine exhaust from the high pressure spool and includes variable inlet guide vanes in order to regulate the speed of the low pressure spool. Compressed air from the low pressure spool is supplied to an inlet of the compressor of the high pressure spool. An interstage cooler can be used to decrease the temperature of the compressed air passed to the high pressure spool.

The twin spool IGT engine with separately operable spools can maintain high component efficiencies of the compressor and turbine at high pressure ratios of 40 to 55, which allow for increased turbine inlet temperatures while keeping the exhaust temperature within today's limits.

Some of the compressed air from the low pressure compressor is passed through an intercooler and then is increased in pressure by a boost compressor in order that the cooling air can pass through a stage of turbine stator vanes to provide cooling and still have enough pressure remaining to be discharged into the combustor.

In another embodiment of the present invention, compressed air from the high pressure compressor is bled off and passed through an intercooler and then through a stage of turbine stator vanes for cooling, and then is increased in pressure in order that the spent cooling air can be discharged into the combustor. In a variation of this embodiment, the cooling air bled off from the high pressure compressor can pass through the turbine stator vanes and then through the intercooler before increasing in pressure in the boost compressor.

With the design of the twin spool IGT engine of the present invention, a gas turbine engine combined cycle power plant can operate with a net thermal efficiency of greater than 67% which is a significant increase over current engine thermal efficiencies.

In addition, current IGT engines used for electrical power production are limited to power output of around 350 MW (for 60 Hertz engines) and 500 MW (for 50 Hertz engines) due to size and mass flow constraints. With the twin spool design of the present invention, existing IGT engines can be retrofitted to operate at close to double the existing maximum power output. One example is the General Electric (GE) 9HA.02 industrial engine which operates at 50 Hertz and produces a maximum output of 470 MW, or the GE industrial engine 7HA.02 for the 60 hertz market that produces a maximum output of 330 MW. The 50 hertz industrial engines can produce more power because they operate at a lower speed, and thus the rotor blades can be longer. The engine flow can thus be larger because of the larger but slower rotating blades based on the AN² limitation. With greater flow comes greater power output.

In a combined cycle power plant that uses very old IGT engines such as the 180 MW IGT engines, a new IGT engine of at least 360 MW would be required and that the turbine exhaust temperature of the new and more powerful IGT engine would be substantially the same at the turbine exhaust temperature of the two older engines in order that the HRSG would not have to be significantly modified with the only modification being in the duct work channeling the hot turbine exhaust from the engine outlet to the HRSG inlet. Replacing two older engines with a single new IGT engine having twice the power would produce a much higher turbine exhaust temperature and thus would require significant modifications of the HRSG in order to accommodate this higher turbine exhaust temperature. The twin spool IGT engine of the present invention would have a similar turbine exhaust temperature of the engines it will be replacing so that no changes to the HRSG would be required. The new IGT engine could be installed to replace the two smaller IGT engines without modification of the HRSG. If the turbine exhaust temperature was too high, then significant changes to the HRSG would be required to allow for the higher temperatures. The single engine of the present invention with the twin spools can produce over 700 MW for a 60 Hertz engine and over 1,000 MW for a 50 Hertz engine.

For a proposed advanced engine cycle, about 20% of the main flow must be cooled and then compressed separately to be available as cooling flow to the high pressure turbine. The addition of a second isolated flow stream in the axial HPC compressor avoids having to add significant support systems for a separate compressor. For example, a separate axial or centrifugal compressor driven by electric motor or gear-box linked to the main gas turbine would be the current known solution.

### BRIEF DESCRIPTION OF THE SEVERAL VIEWS OF THE DRAWINGS

FIG. 1 shows a prior art single shaft spool IGT engine with a direct drive electric generator on the compressor end.

FIG. 2 shows a prior art dual shaft IGT engine with a high spool shaft and a separate power turbine that directly drive an electric generator.

FIG. 3 shows a prior art dual shaft aero gas turbine engine with concentric spools in which a high spool rotates around the low spool, and where a separate low pressure shaft that directly drives an electric generator.

FIG. 4 shows a prior art three-shaft IGT engine with a low pressure spool rotating within a high pressure spool, and a separate power turbine that directly drives an electric generator.

FIG. 5 shows a cross section view of a prior art twin spool aero gas turbine engine with a high spool concentric with and rotatable around the low spool.

FIG. 6 shows a cross section view of a mechanically uncoupled twin spool turbo charged industrial gas turbine engine of the present invention.

FIG. 7 shows a diagram of a gas turbine engine with a fourth embodiment of a mechanically uncoupled turbo charged twin spool industrial gas turbine engine of the present invention.

FIG. 8 shows an embodiment of the twin spool turbo charged industrial gas turbine engine of the present invention in which cooling air for the turbine airfoils is cooled and then boosted in pressure prior to discharge into the combustor.

FIG. 9 shows an embodiment of the twin spool turbo charged industrial gas turbine engine of the present invention similar to the FIG. 24 embodiment except that the cooling air is supplied from bleed air off from the high pressure compressor.

### DETAILED DESCRIPTION OF THE INVENTION

The present invention is a turbo charged twin spool industrial gas turbine engine that drives and electric generator to produce electrical power. The turbocharged IGT engine is associated with a HRSG (Heat Recovery Steam Generator) that drives another electric generator in what is referred to as a combined cycle power plant.

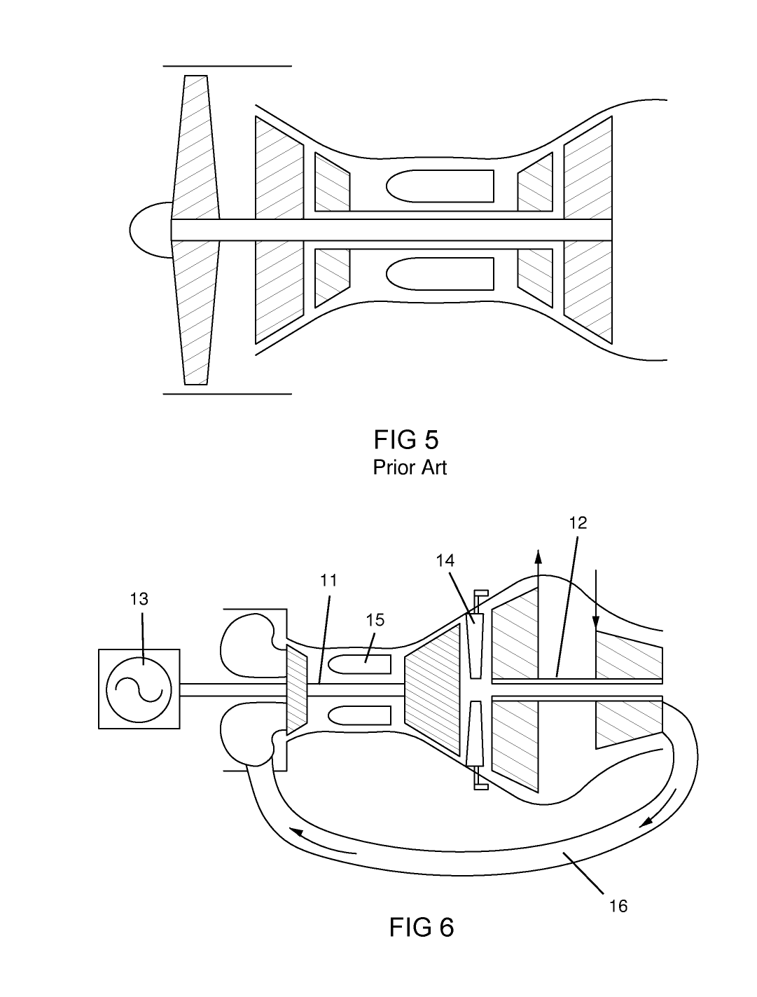

FIG. 6 shows a basic concept of the twin spool turbocharged industrial gas turbine engine of the present invention which includes a high spool 11 with a high pressure compressor driven by a high pressure turbine and a combustor 15, and a low spool 12 with a power turbine that drives a low pressure compressor. Turbine exhaust from the high pressure turbine flows into the power turbine of the low spool 11, where the power turbine drives the low pressure compressor. Variable guide vanes 14 are used in the inlet to the power turbine as well as the high pressure compressor and the low pressure compressor. The low spool 12 is rotatable independent of the high spool 11. Compressed air from the low pressure compressor is delivered to an inlet of the high pressure compressor of the high spool 11. The high spool 11 is connected directly to an electric generator 13. The low spool 12 does not rotate within the high spool 11 as in the prior art industrial engine of FIGS. 3 and 4 or the aero engine of FIG. 5. In the twin spool turbocharged IGT engine of the present invention, the low spool 12 can be referred to as a turbocharger for the main engine or high spool 11.

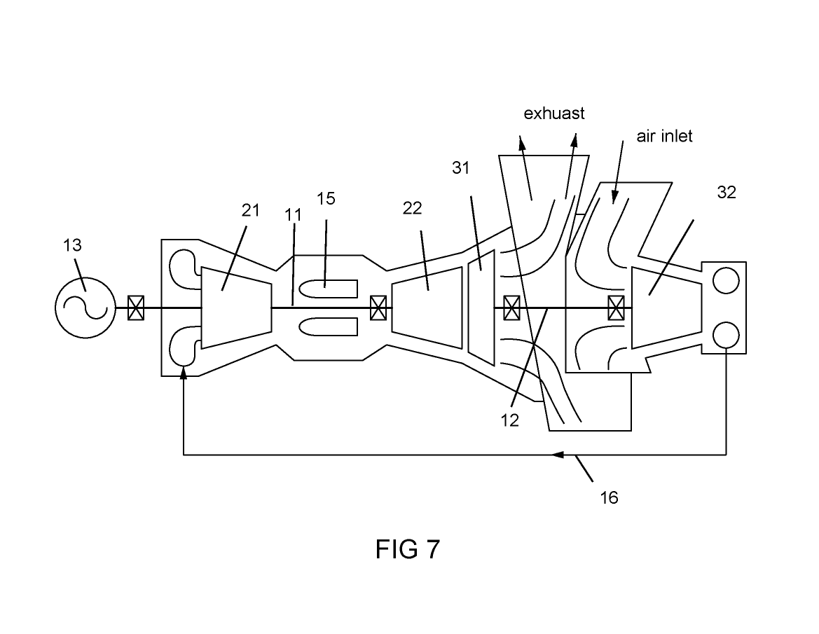

FIG. 7 shows the twin spool turbocharged industrial gas turbine engine of the present invention with the high spool 11 having a high pressure compressor 21 and a high pressure turbine 22 and a low spool 12 having a low pressure compressor 32 and a low pressure turbine 31. The high spool 11 directly drives an electric generator 13. Exhaust from the HPT 22 flows into the LPT or power turbine 31 and then out the exhaust duct and into a HRSG, the power turbine 31 drives the LPC 32 to supply low pressure compressed air through line 16 to an inlet of the HPC 21 of the high spool 11. The low spool 12 with the LPT 31 and the LPC 32 is referred to as the turbocharger for the high spool 11 or main engine.

The low pressure compressor 32 of the low spool 12 includes an inlet guide vane and variable stator vanes that allow for modulating the compressed air flow. Similarly, the high pressure compressor 21 of the high spool 11 can also include variable stator vanes that allow for flow matching and speed control. Thus, the low pressure spool 12 can be shut down and not be operated while the main engine or high speed spool 11 operates to drive the electric generator 13. The low pressure compressor 32 of the low spool 12 is connected by a line 16 to an inlet of the high pressure compressor 21 of the high spool 11. An intercooler can be used in compressed air line 16 between the outlet of the low pressure compressor and the inlet of the high pressure compressor to cool the compressed air. A valve can also be used in the compressed air line 16 for the compressed air from the low pressure compressor 32 to the high pressure compressor 21.

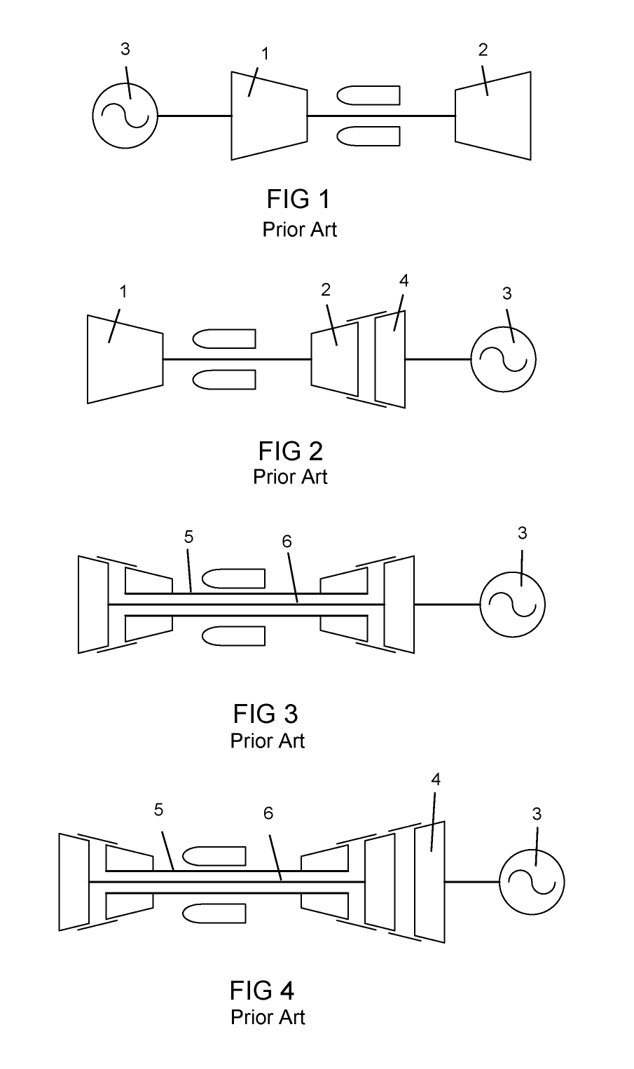

Major advantages of the twin spool turbo-charged industrial gas turbine engine of the present invention are described here. A large frame heavy duty industrial gas turbine engine of the prior art uses only a single spool with the rotor shaft directly connected to an electric generator 3 (see FIG. 1). The FIG. 1 design permits a large amount of power transfer to the generator 3 without the need for a gearbox. In large frame heavy duty industrial engine, a gear box cannot be used because the power output of the engine is far greater than a gear box can be exposed to. Due to these factors, the gas turbine must operate with a very specific rotor speed equal to the synchronization speed of the local electrical power grid. By separating the components of the gas turbine into modular systems according to the present invention, each can then be individually optimized to provide maximum performance within an integrated system. Also, substantial power output and operability improvements can be realized over the prior art industrial engines. For example, the largest 60 hertz IGT engine of the prior art can produce at most 350 MW while the 60 Hertz version of the twin spool turbo-charged industrial engine of the present invention can produce over 700 MW. The largest 50 hertz IGT engine of the prior art can produce at most 500 MW while the 50 Hertz version of the twin spool turbo-charged IGT engine of the present invention can produce over 1,000 MW of power. In both the 50 hertz and 60 hertz versions, the turbine exhaust temperature would be substantially the same as the turbine exhaust temperature of the older IGT engines being replaced such that no substantially modifications or structural changes would be required to the HRSG. Only the duct work channeling the turbine exhaust to the HRSG would need to be modified. In a combined cycle power plant that uses very old engines such as those with 180 MW of power, a single new engine of 360 MW of power could be used to replace these two older IGT engines but the turbine exhaust temperature of the new engine would be significantly higher than the two older engines being replaced such that significant modification or changes would be required of the HRSG to accommodate the higher turbine exhaust temperature. With the twin spool turbo-charged IGT engine of the present invention, one twin spool turbo-charged IGT engine of the present invention could be used to replace the two older 180 MW engines without significant change to the HRSG required.

The efficiency of the gas turbine is known to be largely a function of the overall pressure ratio. While existing IGTs limit the maximum compressor pressure ratio that can be achieved because optimum efficiency cannot be achieved simultaneously in the low and high pressure regions of the compressor while both are operating at the same (synchronous) speed, an arrangement that allows the low pressure compressor 32 and high pressure compressor 21 to each operate at their own optimum rotor speeds will permit the current overall pressure ratio barrier to be broken. In addition, segregating the low pressure and high pressure systems is enabling for improved component efficiency and performance matching. For example, the clearance between rotating blade tips and outer static shrouds or ring segments of existing IGTs must be relatively large because of the size of the components in the low pressure system. In the present invention, the clearances in the high pressure system could be reduced to increase efficiency and performance.

The twin spool turbocharged IGT of the present invention enables a more operable system such that the engine can deliver higher efficiency at turn-down, or part power, and responsiveness of the engine can be improved. Further, this design allows for a greater level of turndown than is otherwise available from the prior art IGTs.

In yet another example, the power output and mass flow of prior art IGT engines is limited by the feasible size of the last stage turbine blade. The length of the last stage turbine blade is stress-limited by the product of its swept area (A) and the square of the rotor speed (N). This is commonly referred to as the turbine AN². For a given rotor speed, the turbine flow rate will be limited by the swept area of the blade. If the rotor speed could be reduced, the annulus area could be increased, and the turbine can then be designed to pass more flow and produce more power. This is the essence of why industrial gas turbines designed for the 50 Hz electricity market, which turn at 3,000 rpm, can be designed with a maximum power output capability which is about 44% greater than an equivalent industrial gas turbine designed for the 60 Hz market (which turns at 3,600 rpm). If the industrial gas turbine engine could be designed with modular components as in the present invention, a separate low pressure system comprising a low pressure compressor 32 and turbine 31 could be designed to operate at lower speeds to permit significantly larger quantities of air to be delivered to the high pressure (core) of the gas turbine.

In prior art IGT engines, size and speed, AN², and limits on the past stage turbine blade eventually lead to efficiency drop-off as pressure ratio and turbine inlet temperatures are increased. In addition, as pressure ratio increases, compressor efficiency begins to fall off due to reduction in size of the back end of the compressor which leads to higher losses. At higher pressure ratios, very small airfoil heights relative to the radius from the engine centerline are required. This leads to high airfoil tip clearance and secondary flow leakage losses. The twin spool turbocharged IGT engine of the present invention solves these prior art IGT engine issues by increasing the flow size of a prior art large IGT engine up to a factor of 2. Normally, this flow size increase would be impossible due to turbine AN² limits. The solution of the present invention is to switch from single spool to independently operable double spool (high spool 11 and low spool 12) which allows for the last stage turbine blade to be designed at a lower RPM which keeps the turbine within typical limits. A conventional design of a dual spool engine would place the electric generator on the low spool, fixing the speed of the electric generator, and have a higher RPM high spool engine. With the twin spool turbocharged IGT engine of the present invention, the electric generator 13 is located on the high spool 11, and has a variable speed low spool 12. This design provides numerous advantages. Since the low spool 12 is untied from the grid frequency, a lower RPM than synchronous can be selected allowing the LPT 31 to operate within AN² limits. Another major advantage is that the low spool 12 RPM can be lowered significantly during operation which allows for a much greater reduction of engine air flow and power output than can be realized on a machine with a fixed low spool speed. The twin spool turbocharged IGT of the present invention maintains a higher combustion discharge temperature at 12% load than the prior art single spool IGT operating at 40% load. In the twin spool turbocharged IGT engine of the present invention, power was reduced by closing the inlet guide vanes on the high pressure compressor 21. Low and high pressure compressor aerodynamic matching was accomplished using a variable LPT vane which reduces flow area into the LPT, thus reducing the RPM of the low spool 12.

A prior art single spool IGT is capable of achieving a low power setting of approximately 40-50% of max power. The twin spool turbocharged IGT engine of the present invention is capable of achieving a low power setting of around 12% of max power. This enhanced turndown capability provides a major competitive advantage given the requirements of flexibility being imposed on the electrical grid from variable power generation sources.

During periods of high electrical power demand, the main engine with the high spool 11 is operated to drive the electric generator 13 with the gas turbine exhaust going into the power turbine 31 of the low spool 12 to drive the low pressure compressor 32. The exhaust from the power turbine 31 of the low spool 12 then flows into the HRSG to produce steam to drive a steam turbine that drives a second electric generator. The low pressure compressed air from the low spool 12 flows into the inlet of the high pressure compressor 21 of the high spool 11.

During periods of low electrical power demand, the low pressure compressor 32 of the low spool 12 is operated at low speed and the exhaust from the high pressure turbine 22 of the high spool 11 flows into the HRSG through the low pressure turbine 31 of the low spool 12 to produce steam for the steam turbine that drive the second electric generator and thus keep the parts of the HRSG hot for easy restart when the engine operates at higher loads. Flow into the high pressure compressor 21 of the high spool 11 is reduced to 25% of the maximum flow. Thus, the high spool 11 can go into a very low power mode. The prior art power plants have a low power mode of 40% to 50% (with inlet guide vanes in the compressor) of peak load. The Turbocharged IGT engine of the present invention can go down to 25% of peak load while keeping the steam temperature temporarily high of the power plant hot (by passing the hot gas flow through) for easy restart when higher power output is required. An intercooler can also include water injection to cool the low pressure compressed air.

At part power conditions between full power and the lowest power demand, it may be necessary to operate the low pressure compressor 32 of the low spool 12 and low pressure turbine 31 at an intermediate rotor speed. A means for controlling the engine is necessary in order to reduce low spool 12 rotor speed without shutting off completely, while ensuring stable operation of the low pressure compressor 32 and high pressure compressor 21. Without a safe control strategy, part power aerodynamic mismatching of the compressors can lead to compressor stall and/or surge, which is to be avoided for safety and durability concerns. A convenient way to control the low spool 12 speed while correctly matching the compressors aerodynamically is by means of a variable low pressure turbine vane. Closing the variable low pressure turbine vane at part power conditions reduces the flow area and flow capacity of the low pressure turbine 31, which subsequently results in a reduction of low pressure spool 12 rotational speed. This reduction in rotor speed reduces the air flow through the low pressure compressor 32 which provides a better aerodynamic match with the high pressure compressor 21 at part power.

While the evolution of the current state-of-the-art industrial gas turbine engine has found broad utility in the electricity generation market, the efficiency of these machines is limited because of the engineering tradeoffs that have been accepted without that evolution. Interestingly, the evolution of gas turbine engines for aircraft propulsion has taken a decidedly different direction. There, weight, performance/efficiency, and operability are the design drivers that are paramount to the successful evolution of turbomachinery for that application. To improve efficiency, aircraft (aero) engines have been designed to operate at higher pressure ratios than industrial (IGT) engines. Further, the vast majority of aircraft (aero) gas turbine systems have multiple shafts whereby the low pressure components (i.e., low pressure compressor, low pressure turbine) reside on what is called a low spool. High pressure components such as the high pressure compressor and the high pressure turbine reside on the high spool. The two spools operate at different speeds to optimize the efficiency of each spool. The use of multiple shafts in a gas turbine engine yields benefits that increase component and overall efficiency, increase power output, improve performance matching, and improve operability. The latter is manifested in both responsiveness of the engine and in part-power performance.

The twin spool turbocharged industrial gas turbine engine of the present invention offers many advantages relative to the current state-of-the-art engines. By separating the components of the gas turbine into modular systems, each can then be individually optimized to provide maximum performance within an integrated system. In addition, substantial power output and operability improvements can be obtained.

In one example, the efficiency of the gas turbine can be increased using modular components. The efficiency of the gas turbine is known to be largely a function of the overall pressure ratio. While existing IGTs limit the maximum compressor pressure ratio that can be achieved because optimum efficiency cannot be achieved simultaneously in the low and high pressure regions of the compressor while both are operating at the same (synchronous) speed, an arrangement that allows the low and high pressure compressors to each operate at their own optimum rotor speeds will permit the current overall pressure ratio barrier to be surpassed. In addition, segregating the low and high pressure systems is enabling for improving component efficiency and performance matching. For example, the clearances between the rotating and non-rotating hardware such as in clearances between rotating blade tips and stationary outer shrouds or ring segments of existing IGTs must be relatively large because of the size of the components in the low pressure system. In the configuration of the present invention, the clearances in the high pressure system could be reduced to increase efficiency and performance.

In another example, the component technology of the turbocharged IGT engine of the present invention enables a more operable system such that an engine can deliver higher efficiency at turn-down or part power, and responsiveness of the engine can be improved. Further, this modular arrangement allows for a greater level of turndown than is otherwise available from the prior art large frame heavy duty IGTs of the prior art. This is important when considering the requirements imposed on the electrical grid when intermittent sources of power such as solar and wind become an increasing percentage of the overall capacity.

In yet another example, the power output and mass flow of prior art large frame heavy duty IGTs is limited by the feasible size of the last stage turbine rotor blade. The length of the last stage turbine rotor blade is stress-limited by the product of its swept area (A) and the square of the rotor speed (N). This is referred to in the art as the turbine AN². For a given rotor speed (N), the turbine flow rate will be limited by the swept area of the last stage blade. If the rotor speed (N) could be reduced, the annulus area could be increased, and the turbine can then be designed to pass more flow and produce more power. This is the essence of why gas turbines designed for the 50 Hertz (3,000 rpm) electricity market can be designed with a maximum power output capability which is about 44% greater than an equivalent gas turbine designed for the 60 Hertz (3,600 rpm) market. If the gas turbine engine could be designed with modular components, a separate low pressure system comprising a low pressure compressor and turbine could be designed to operate at lower speeds to permit significantly larger quantities of airflow to be delivered to the high pressure (core) of the gas turbine engine.

Limitations exist in the prior art gas turbine engine design. Size and speed, AN², limits on the last stage turbine rotor blade eventually lead to efficiency drop-off as pressure ratio and turbine inlet temperature (TIT) are increased. In addition, as pressure ratio increases, compressor efficiency begins to fall off due to reduction in size of the back end of the compressor which leads to higher losses. The root cause of that efficient aerodynamic work per stage improves with higher airfoil rotational speed. This means that the aerodynamic engineer tries to keep a relatively high radius placement. At high pressure ratios, this leads to very small airfoil heights relative to radius from the engine centerline. This leads to high airfoil tip clearance and high secondary flow leakage losses.

Higher engine efficiency is obtained with higher pressure ratio and higher turbine inlet temperature. The first obstacle is reduction of component efficiencies due to size effects because of the higher pressure ratio. The IGT engine of the present invention solves this issue by increasing the flow size of a typical large frame IGT by a factor of 2. Normally, this flow size increase would be impossible due to the turbine AN² limits. The IGT engine of the present invention solution is to switch from a single spool engine to a dual spool engine with the two spools capable of operating independently where the low spool does not rotate within the high spool. This allows for the last stage blade to be designed at a lower RPM which keeps the turbine within limits. Prior art design of a dual spool engine would place the electric generator on the low spool, fixing its speed, and have a higher RPM high spool engine. The IGT engine of the present invention goes against this convention and places the electric generator on the high spool, and has a variable speed low spool. This arrangement provides for numerous advantages. Since the low spool is untied from the grid frequency, a lower PRM than synchronous can be selected allowing for the LPT to operate within AN² limits. Another major advantage is that the low spool RPM can be lowered significantly during operation which allows for a much greater reduction of engine air flow, and power can be realized on a machine with a fixed low speed spool. The IGT engine of the present invention can maintain a higher combustion discharge temperature at 12% load than the prior art single spool IGT engines operating at a 40% load.

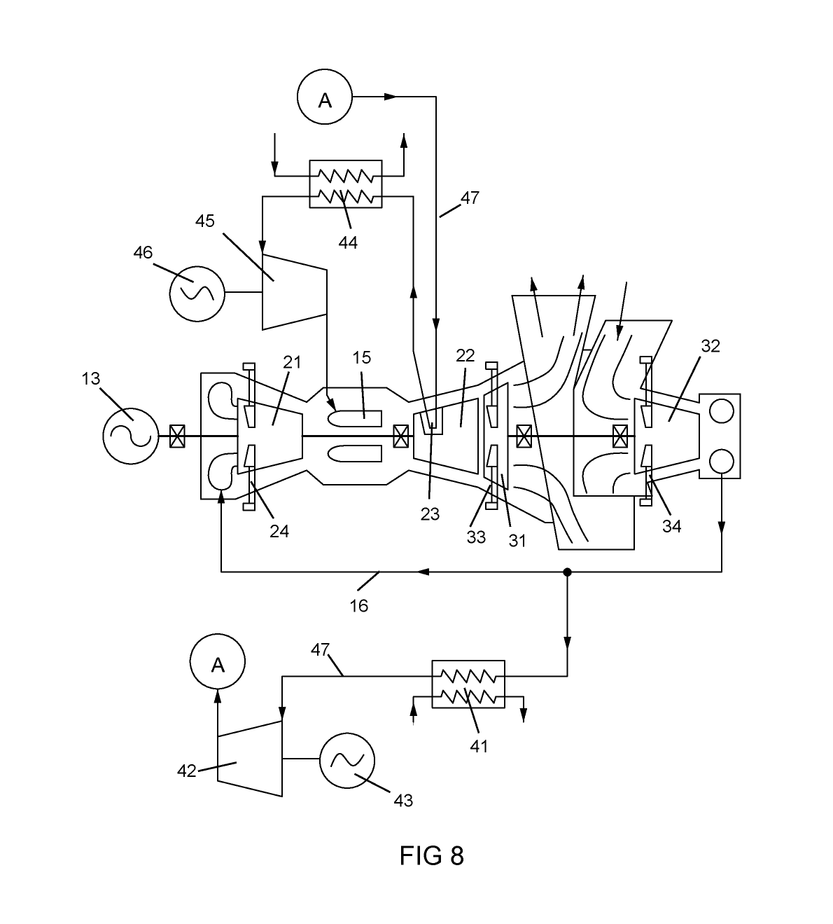

FIG. 8 shows the twin spool turbocharged industrial gas turbine engine of the present invention in which cooling air for the high pressure turbine airfoils is boosted in pressure by a boost pump downstream from the airfoils in order to be discharged into the combustor at about the same pressure as the compressor discharge pressure. Compressed air from the low pressure compressor 32 is bled off from the main bypass flow 16 and passed through an intercooler 41 where the temperature of the compressed air is lowered. The lower temperature compressed air is then boosted in pressure by a first cooling air compressor 42 driven by a motor 43 to a pressure suitable for cooling the turbine airfoils such as the stator vanes 23 in the high temperature turbine 22. The spent cooling air is then passed through a second intercooler 44 and then a second cooling air compressor 45 driven by a second motor 46 to boost the pressure so that the compressed air used to cool the stator vane 23 will be at a pressure substantially matching the outlet pressure of the high pressure compressor 21 for discharge into the combustor 15. With the embodiment in FIG. 8, the compressed air pressure passing through the air cooled airfoils 23 does not have to be high enough to both cool the airfoils and be high enough for discharge into the combustor 15. This would require higher pressure seals. With the FIG. 8 embodiment, the extra pressure is added to the cooling air after passing through the air cooled airfoils so that lower pressure seals can be used. The HPC 21 includes variable inlet guide vanes 24, the LPT 33 includes variable inlet guide vanes 33, and the LPC 32 includes variable inlet guide vanes 34 in order to allow for the higher power output of the twin spool turbocharged IGT engine of the present invention as well as the low turn-down speed.

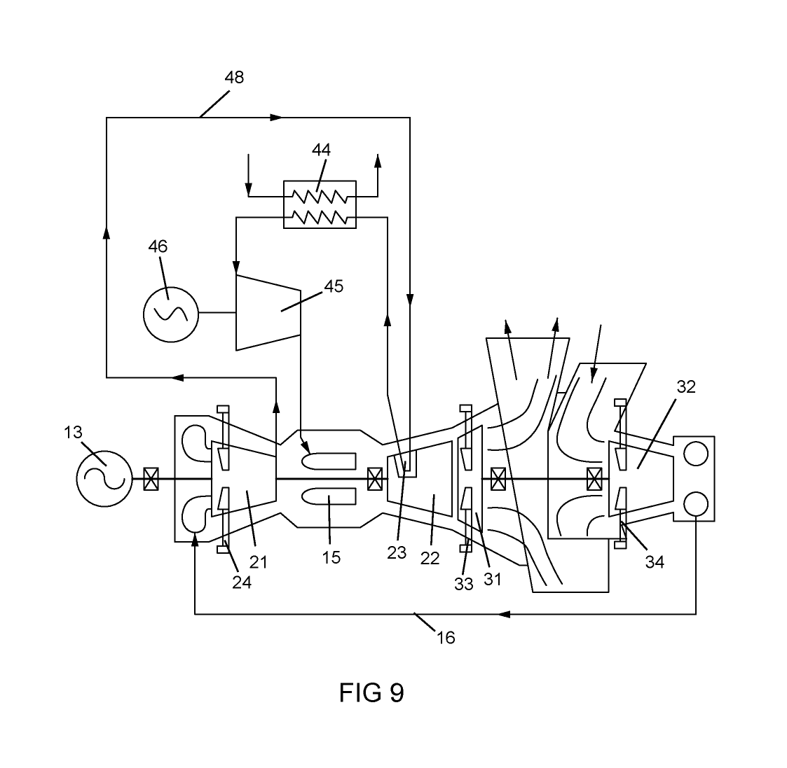

FIG. 9 shows another embodiment of the turbocharged industrial gas turbine engine similar to the FIG. 8 embodiment except that the cooling air for the turbine airfoil 23 is bled off from the high pressure compressor 21 (instead of the low pressure compressor 32), then passed through cooling passage and the turbine airfoil such as the row of stator vanes 23 to provide cooling. The spent cooling air in line 48 is passed through an intercooler 44 to further cool the spent cooling air and is then increased in pressure by the boost compressor 45 driven by the motor 46 to a high enough pressure that it can be discharged into the combustor 15 at substantially the same pressure as the high pressure compressor 21 discharge.

In both embodiments of FIGS. 8 and 9 of the twin spool turbocharged IGT engine of the present invention, high pressure is produced in the cooling air of the turbine airfoils so that the cooling air can be discharged into the combustor 15 without requiring higher pressure seals in the cooling air flow paths through the turbine and airfoils.

We claim the following:

1: An industrial gas turbine engine to produce electrical power comprising:
a main engine with a high pressure compressor driven by a high pressure turbine and a combustor to produce a hot gas stream;
a direct drive electric generator connected to the main engine;
a turbocharger having a low pressure turbine driving a low pressure compressor;
the low pressure turbine driven by exhaust from the high pressure turbine;
a compressed air bypass line connecting the low pressure compressor to the high pressure compressor;
a first row of variable inlet guide vanes in the high pressure compressor;
a second row of variable inlet guide vanes in the low pressure turbine;
a third row of variable inlet guide vanes in the low pressure compressor;
a stage of turbine stator vanes with a cooling circuit in the high pressure turbine;
a source of air cooling located upstream from the cooling circuit of the stage of turbine stator vanes to provide cooling air;
an intercooler and a boost compressor located downstream from the cooling circuit of the stage of turbine stator vanes and connected to the combustor; and,
cooling air from the source of cooling air passing through the cooling circuit of the stage of turbine stator vanes to provide cooling to the stage of turbine stator vanes, and then flows through the intercooler to be cooled, and then is boosted in pressure by the boost compressor to a high enough pressure to be discharged into the combustor.

2: The industrial gas turbine engine to produce electrical power of claim 1, and further comprising:
the source of cooling air is a cooling air line connected to the compressed air bypass line; and,
a second intercooler and a second boost compressor is located in the cooling air line upstream of the cooling circuit of the stage of turbine stator vanes.

3: The industrial gas turbine engine to produce electrical power of claim 1, and further comprising:
the source of cooling air is the high pressure compressor.

4: The industrial gas turbine engine to produce electrical power of claim 1, and further comprising:
the industrial gas turbine engine is a 60 hertz engine capable of producing greater than 700 MW of power.

5: The industrial gas turbine engine to produce electrical power of claim 1, and further comprising:
the industrial gas turbine engine is a 50 hertz engine capable of producing greater than 1,000 MW of power.

6: The industrial gas turbine engine to produce electrical power of claim 1, and further comprising:
the turbocharger is capable of rotating independently from the main engine.

7: The industrial gas turbine engine to produce electrical power of claim 1, and further comprising:
the electric generator and the main engine operate equal to a synchronization speed of a local electrical power grid.

8: An industrial gas turbine engine to produce electrical power comprising:
a compressor capable of discharging compressed air at a compressor discharge pressure;
a turbine connected to drive the compressor;
an electric generator connected to the industrial gas turbine engine to produce electrical power;
a row of turbine stator vanes with an internal cooling circuit;
a combustor to produce a hot gas stream for the turbine from compressed air discharged from the compressor;
a turbine stator vane cooling circuit having an inlet connected to a source of compressed air and an outlet connected to the combustor;
the turbine stator vanes cooling circuit connected to the turbine stator vane internal cooling circuit to supply and return cooling air to the turbine stator vanes cooling circuit;
an intercooler connected to the turbine stator vane cooling circuit to cool the cooling air; and,
a boost compressor connected to the turbine stator vane cooling circuit to increase a pressure of the cooling air to a pressure greater than the compressor discharge pressure; wherein,
cooling air from the source of compressed air passes through the turbine stator vane cooling circuit and then into the combustor at a pressure greater than the compressor discharge pressure.

9: The industrial gas turbine engine to produce electrical power of claim 8, and further comprising:
the source of compressed air is the compressor.

10: The industrial gas turbine engine to produce electrical power of claim 8, and further comprising:
the intercooler is located downstream from the turbine stator vane cooling circuit; and,
the boost compressor is located downstream from the intercooler.
